(19) United States
(12) Patent Application Publication
(10) Pub. No.: US 2007/0133036 A1
(43) Pub. Date: Jun. 14, 2007

(54) Image-processing apparatus, image-processing method, and program product for image processing

(75) Inventors: Junichi Matsunoshita, Kanagawa (JP); Shin Kondo, Kanagawa (JP); Tsutomu Kimura, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/472,251

(22) Filed: Jun. 22, 2006

(30) Foreign Application Priority Data
Dec. 13, 2005 (JP) 2005-359645

(51) Int. Cl. G06K 15/00

(52) U.S. Cl. 358/1.14; 382/112

(57) ABSTRACT

An image-processing apparatus includes a scanning portion that scans a document in which information is embedded; an image-outputting portion that outputs an image of the document that has been scanned; a detecting portion that detects information from the image of the document that has been scanned; an abnormality determining portion that determines whether or not there is an abnormality in the image of the document that has been scanned; and a controller that controls outputting of the image from the image-outputting portion, on the basis of a detection result by the detecting portion and a determination result of the abnormality determining portion.

### CROSS-REFERENCE TO RELATED APPLICATION

This application claims priority under 35 USC 119 from Japanese patent document, 2005-359645, the disclosure of which is incorporated by reference herein.

### BACKGROUND

1. Technical Field

This invention generally relates to an image-processing apparatus and image-processing method, by which information leakage of a confidential document can be prevented.

2. Related Art

In recent years, there have been problems of information leakage by unauthorized copying of a confidential document that has been printed out, with the use of the widely spread personal computers, printers, and copying machines. As a conventional technique of preventing the unauthorized copying of the confidential document, there has been proposed a complex machine having a function of unauthorized copy inhibit. According to the function of unauthorized copy inhibit, when a confidential document is printed out, copy inhibit information is embedded in an image and then the image is printed out. When the document that has been printed out is copied, the copy inhibit information embedded in the image is detected from the image of the document. If the copy inhibit information is included, a normal copy operation is stopped.

There has also been proposed a sophisticated complex machine with an advanced unauthorized copy inhibit function. When a confidential document is printed out, two types of information, which are copy inhibit information and copy permit condition information, are embedded in the image. The copy permit condition information (for example, password) is used for permitting making a copy under a specific condition. When the document that has been printed out is copied, the two types of information embedded in the image, which are the copy inhibit information and the copy permit condition information, are detected from the image that has been read. Then, it is determined whether or not the two types of information are matched with a copy permit condition. If the copy permit condition is not matched, the copy operation is stopped. If matched, the copy operation is performed. Here, as a method of embedding the copy inhibit information and the copy permit condition information, a following one has been proposed.

A tint block background image having a relatively low density of minute patterns is synthesized on a whole background of a document image. The tint block backgroundi mage is composed of two areas: a latent character area and a background area. The two areas respectively include different minute patterns. The latent character area is composed of relatively small dot patterns, and the background area is composed of an arrangement of two kinds of minute slant patterns. These two kinds of minute slant patterns respectively represent bit 0 and bit 1. An image of two-dimensional code is made up with a two-dimensional arrangement having a given size formed of the two kinds of the slant patterns, and multiple images of two-dimensional codes are repeatedly and adjacently arranged on the background. The copy permit condition information is embedded in the two-dimensional code.

The copy inhibit information is embedded by a specific code composed of the slant patterns corresponding to all bits of 0 in the two-dimensional arrangement or by another specific code composed of the slant patterns corresponding to all bits of 1 in the two-dimensional arrangement. As another conventional technique for preventing the unauthorized copy of the confidential document, there has been proposed an image-processing apparatus. The confidential document is printed out, after the information on the user who is printing out, information on time and date, or the like is embedded. Then, the document that has been printed out is scanned by a scanner or the like. The user, client PC, printer, or the time and date embedded in the image is analyzed from the canned image, in order to identify a source of the information leakage. This function can be configured as an additional function of the complex machine of one of the conventional techniques.

In the above-described conventional techniques, however, there is a problem in that the copy inhibit code cannot be detected correctly, if the image to be scanned is blurred due to an error of a scanner mount position or the like, since the code is made up with a shape of the minute patterns. Consequently, a copy can be made regardless of the copy inhibit document.

### SUMMARY

An aspect of the present invention provides an image-processing apparatus including: a scanning portion that scans a document in which information is embedded; an image-outputting portion that outputs an image of the document that has been scanned; a detecting portion that detects information from the image of the document that has been scanned; an abnormality determining portion that determines whether or not there is an abnormality in the image of the document that has been scanned; and a controller that controls outputting of the image from the image-outputting portion, on the basis of a detection result by the detecting portion and a determination result of the abnormality determining portion.

### BRIEF DESCRIPTION OF THE DRAWINGS

Embodiments of the present invention will be described in detail based on the following figures, wherein:

FIG. 1 is a view showing a configuration of a multifunctional peripheral according to an exemplary embodiment of the present invention;

FIG. 2A through FIG. 2C are schematic views illustrating codes;

FIG. 3A and FIG. 3B are schematic views illustrating pattern number sequences;

FIG. 4A through FIG. 4C are schematic views illustrating patterns;

FIG. 5A through FIG. 5C are schematic views illustrating examples of a print output and copy output;

FIG. 6 is a block diagram of a scanned image abnormality determining portion;

FIG. 7 is a block diagram of a background image density determining portion;

FIG. 8 is a block diagram of an image frequency determining portion;

FIG. 9A is a density histogram of a case where the document is scanned as usual;

FIG. 9B is a density histogram of a case where the document is scanned in a floating state;

FIG. 10A is a high-frequency component pixel value histogram of a case where the document is scanned as usual;

FIG. 10B is a high-frequency component pixel value histogram of a case where the document is scanned in a floating state; and

FIG. 11 is a flowchart of copy operation of the multifunctional peripheral according to an exemplary embodiment of the present invention.

### DETAILED DESCRIPTION

A description will now be given, with reference to the accompanying drawings, of embodiments of the present invention.

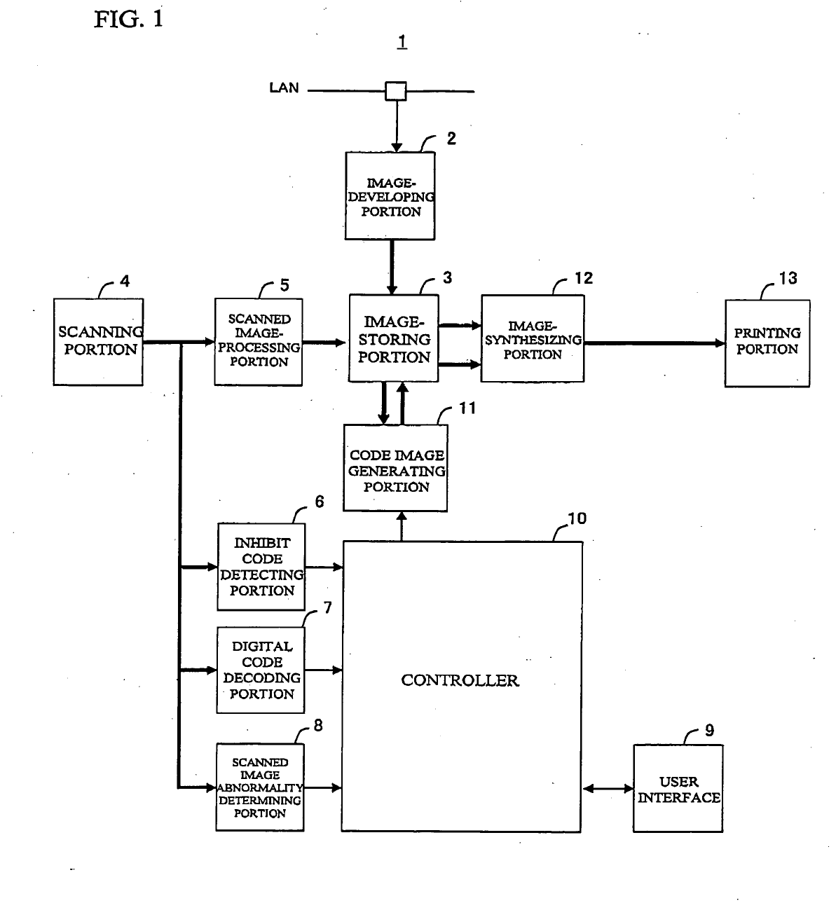

FIG. 1 is a view showing a configuration of a multifunctional peripheral 1. The multifunctional peripheral that serves as an image-processing apparatus has multiple functionalities of print function, copy function, and scan function. The multifunctional peripheral 1 is connected to a client personal computer (PC) connected to a network such as a Local Area Network (LAN) or the like. The multifunctional peripheral 1 includes an image-developing portion 2, an image-storing portion 3, a scanning portion 4, a scanned image-processing portion 5, an inhibit code detecting portion 6, a digital code decoding portion 7, a scanned image abnormality determining portion 8 that serves as an abnormality determining portion, a user interface 9, a controller 10, a code image generating portion 11, an image-synthesizing portion 12, and a printing portion 13 that serves an image-outputting portion.

The image-developing portion 2 performs drawing processing of print data (hereinafter, referred to as PDL data) written in a print description language (PDL) to generate document image data, after the print data is input through the LAN. Such drawn document image data is stored in the image-storing portion 3. The image-storing portion 3 stores a document image and a code image in association with a page number. The scanning portion 4 scans a document placed on a platen, and outputs the document that has been scanned to the scanned image-processing portion 5. The scanned image-processing portion 5 performs image processing such as image correction, color conversion, scaling up or down, and the like, and stores in the image-storing portion 3.

The inhibit code detecting portion 6 detects an inhibit code (information) in the scanned image. The digital code decoding portion 7 decodes a digital code of the scanned image. The scanned image abnormality determining portion 8 determines whether or not there is an abnormality in the scanned image. For example, the scanned image abnormality determining portion 8 determines that there is an abnormality in an image in a case where the document is scanned in a floating state from the scanning portion 4. At this time, the scanned image abnormality determining portion 8 determines whether or not there is an abnormality in the scanned image on the basis of a background density of the scanned image. Also, the scanned image abnormality determining portion 8 determines whether or not there is an abnormality in the scanned image on the basis of a pixel value of a high-frequency component in the scanned image. The user interface 9 includes an input/output device such as a touch panel display or the like, and is provided for receiving inputs of the user's various operations and embedded information.

The controller 10 controls the whole multifunctional peripheral 1. The controller 10 controls outputting of the image, on the basis of a result from the inhibit code detecting portion 6, the digital code decoding portion 7, or the scanned image abnormality determining portion 8. The controller 10 respectively encodes fixed information, job information, and page unit information, as a fixed information code, a job information code, and a page information code. The code image generating portion 11 locates respective codes encoded by the controller 10 in given areas of an image to generate a code image. The image-synthesizing portion 12 reads and synthesizes the document image and the code image stored in the image-storing portion 3. The printing portion 13 outputs a synthesized image that has been synthesized by the image-synthesizing portion 12 to print and record on a paper.

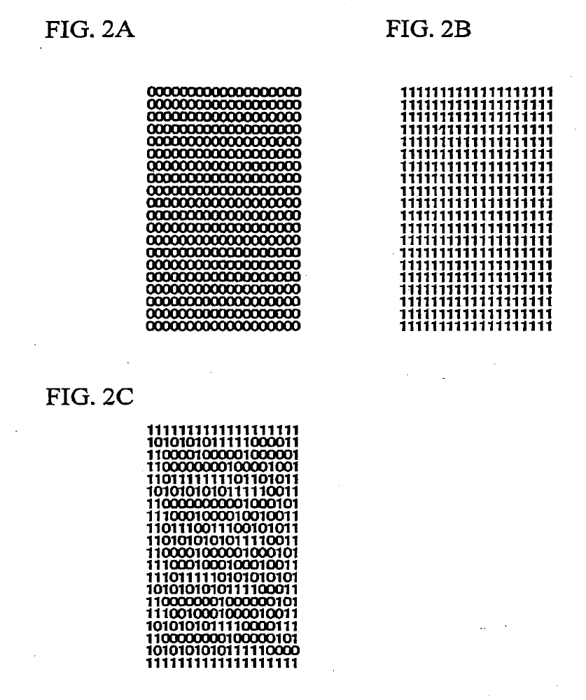

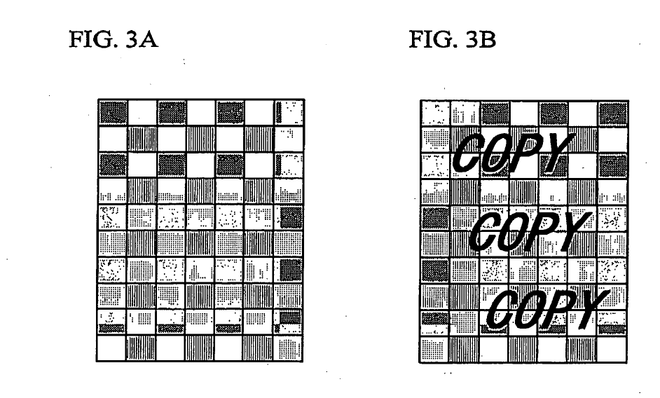

Next, a description is given to a generating process of a tint block background image. FIG. 2A through FIG. 2C are schematic views illustrating codes FIG. 3A and FIG. 3B are schematic views illustrating pattern number sequences. The operation of the code image generating portion 11 is described. Additional information (copy inhibit information, condition information, and latent image information) is input into the code image generating portion 11 from the controller 10. The code image generating portion 11 generates the latent image information according to such input latent image information. The latent image information denotes information on what kind of a latent character is to be embedded in a pattern image. Specifically, the latent image information is composed of a character string of the latent image, font type thereof, font size thereof, direction (angle) of the latent character string and the like. The code image generating portion 11 draws a character string of the latent image in a designated font type, in a designated font size, and in a designated direction, and produces as a binary latent image.

The resolution of the latent image is calculated by dividing a printer resolution by a pattern size, which will be described later. An example is that the resolution of the latent image is 50 dpi, where the printer resolution is 600 dpi and the pattern size is 12 pixels×12 pixels. The code image generating portion 11 encodes the copy inhibit information and the condition information that have been input.

Firstly, when the copy inhibit information represents that the document that has been printed out is prohibited from being copied on the image-forming apparatus, two kinds of copy inhibit codes are produced as shown in FIG. 2A and FIG. 2B. Here, it is noteworthy that the copy inhibit code of FIG. 2A has all the bits of 0 in the code, and the copy inhibit code of FIG. 2B has all the bits of 1 in the code. If the copy inhibit information is not input, or if the information does not mean that the printed document is not allowed to be copied on an image-forming apparatus, the two kinds of codes of FIG. 2A or FIG. 2B are not produced.

Next, if the condition information is input, error correction is performed on the condition information and a digital code shown in FIG. 2C is produced. The code of FIG. 2C represents a bit sequence of the encoded condition information with the arrangement of the bits of 0 and bits of 1. The perimeter of the code has a specific bit pattern to facilitate the code positioning. Subsequently, multiple codes that have been produced are arranged repeatedly as shown in FIG. 3A to produce a pattern number sequence having a size identical to that of the latent image. Here, a slanted hatched rectangle indicates the copy inhibit code of FIG. 2A. A vertical hatched rectangle indicates the copy inhibit code of FIG. 2B. A dotted hatched rectangle indicates the digital code of FIG. 2C.

Unless the copy inhibit code is produced, the digital code is arranged instead of the copy inhibit code in figures. Unless the digital code is produced, the copy inhibit code is arranged instead of the digital code. At this time, each element has a value of 0 or 1 in the pattern number sequence. Then, referring to the latent image, a pattern number of an element in the pattern number sequence that corresponds to a coordinate of a black pixel in the latent image is-changed to 2. When this process is performed for all the black pixels in the latent image, the pattern number sequence becomes a state where a latent character is drawn by a pattern number 2 on the background where the copy inhibit codes and the digital codes are arranged. This state is shown in FIG. 3B. “COPY” drawn in black in FIG. 3B corresponds to a portion in which the pattern number sequence is changed to 2. The pattern number sequence is output to the code image generating portion 11.

The code image generating portion 11 refers to each element of the pattern number sequence that has been input, reads a pattern that corresponds to the pattern number sequence from a pattern storing portion to convert into the pattern image, and produces the tint block background image. Such produced tint block background image is stored in the image-storing portion 3.

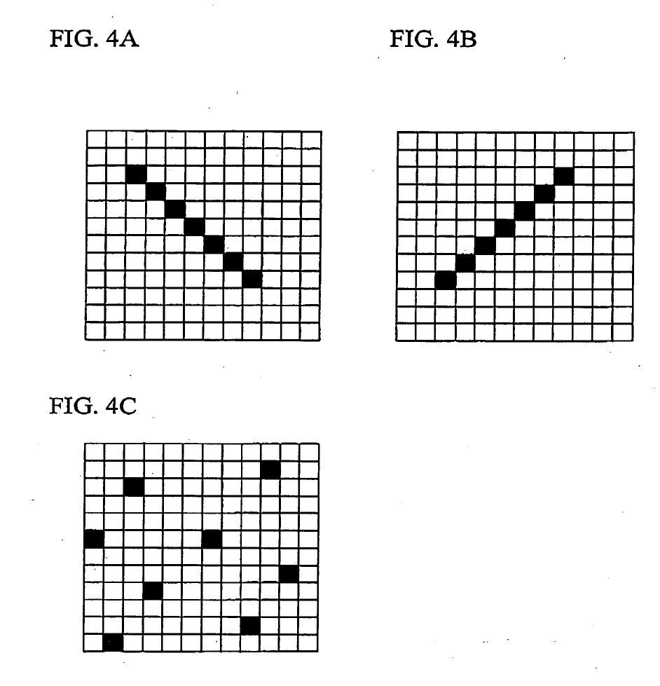

FIG. 4A through FIG. 4C are schematic views illustrating patterns stored in the pattern storing portion. FIG. 4A shows a pattern corresponding to a pattern number 0. FIG. 4B shows a pattern corresponding to a pattern number 1. FIG. 4C shows a pattern corresponding to a pattern number 2. Here, the pattern number sequence corresponds to a resolution of an image obtained by dividing the printer resolution by the pattern size. The pattern image generated on the basis of the pattern number sequence is produced by replacing one element of the pattern number sequence with one pattern. Accordingly, such produced pattern is matched with the printer resolution. Also, the pattern image is converted into slant patterns corresponding to the copy inhibit code and a bit value of the digital code. The latent character is converted into an image of isolated dot patterns.

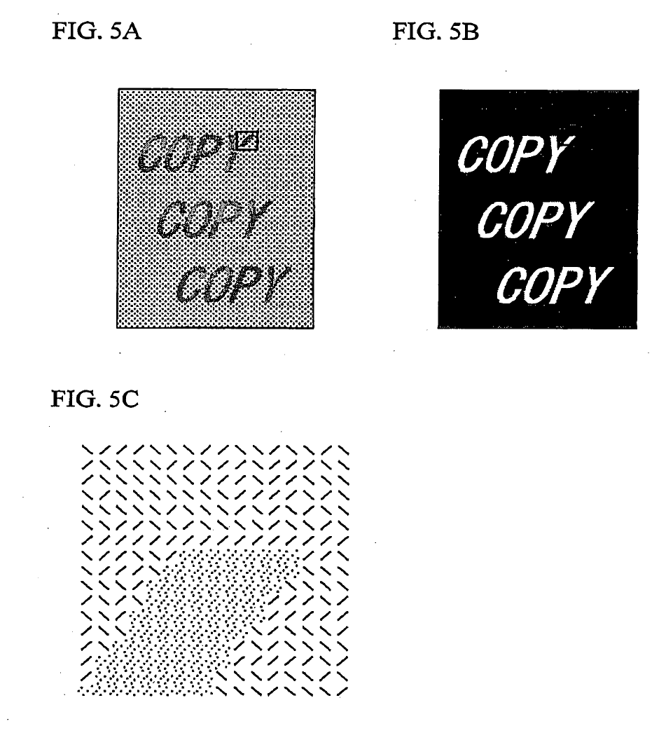

The pattern image produced in this manner is stored in the image-storing portion 3 as a tint block background image, is synthesized with the document image data, and is printed out on a paper. FIG. 5A through FIG. 5C are schematic views illustrating examples of copy outputs. FIG. 5A shows an example of a printed out image (for convenience of explanation, there is shown a case where the document image is colored white without an image element). FIG. 5C is an enlarged view of an area surrounded by a rectangle in FIG. 5A. FIG. 5B is a copied image when the image of FIG. 5A is copied by a copying machine.

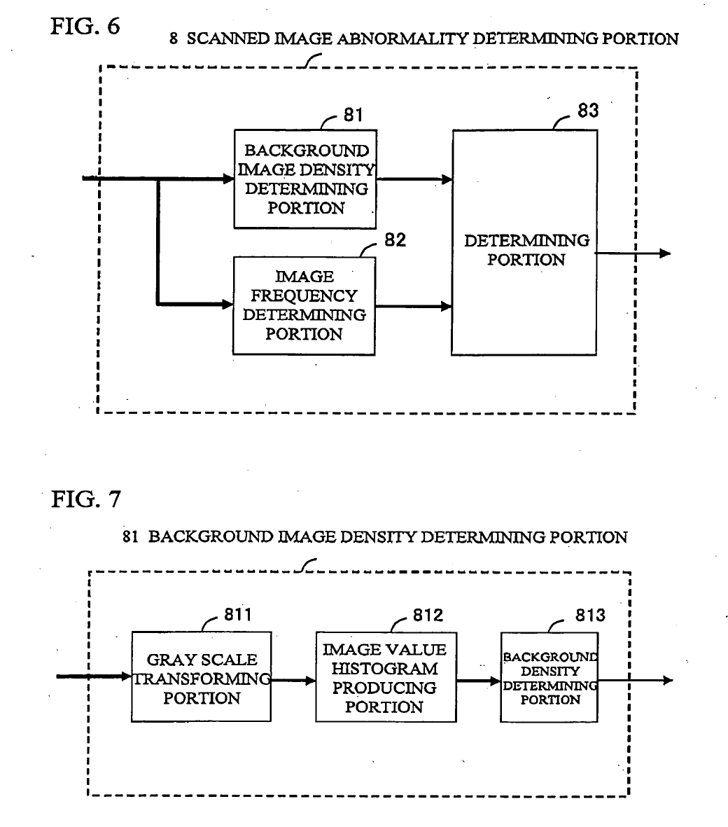

Next, a description is given of the scanned image abnormality determining portion 8. FIG. 6 is a block diagram of the scanned image abnormality determining portion 8. The scanned image abnormality determining portion 8 includes a background image density determining portion 81, an image frequency determining portion 82, and a determining portion 83, by reference to FIG. 6. The image scanned by the scanning portion 4 is input into the background image density determining portion 81 and the image frequency determining portion 82. The background image density determining portion 81 determines the density of the background image. The image frequency determining portion 82 determines the frequency of the image.

FIG. 7 is a block diagram of the background image density determining portion 81. The background image density determining portion 81 includes a gray scale transforming portion 811, an image value histogram producing portion 812, and a background density determining portion 813. The gray scale transforming portion 811 transforms an input image (RGB) into gray scales, at first. The image value histogram producing portion 812 plots a histogram of all pixel values (density histogram). Referring to FIG. 9A and FIG. 9B, the distributions are different in the density histogram, in that the image is scanned as usual (the document is placed on the platen) and the document is scanned in a floating state. FIG. 9A is a density histogram of a case where the document is scanned as usual. FIG. 9B is a density histogram of a case where the document is scanned in a floating state. In FIG. 9A and FIG. 9B, the horizontal axis denotes the pixel value, and the vertical axis denotes frequency. The background density determining portion 813 divides the histogram into three areas, so as to determine the abnormality of the image with the ratio of a middle histogram. The background density determining portion 813 determines that there is an abnormality in the image in a case where the distribution similar to FIG. 9B is obtained, because the image becomes dark and the background becomes denser when the document is scanned in a floating state.

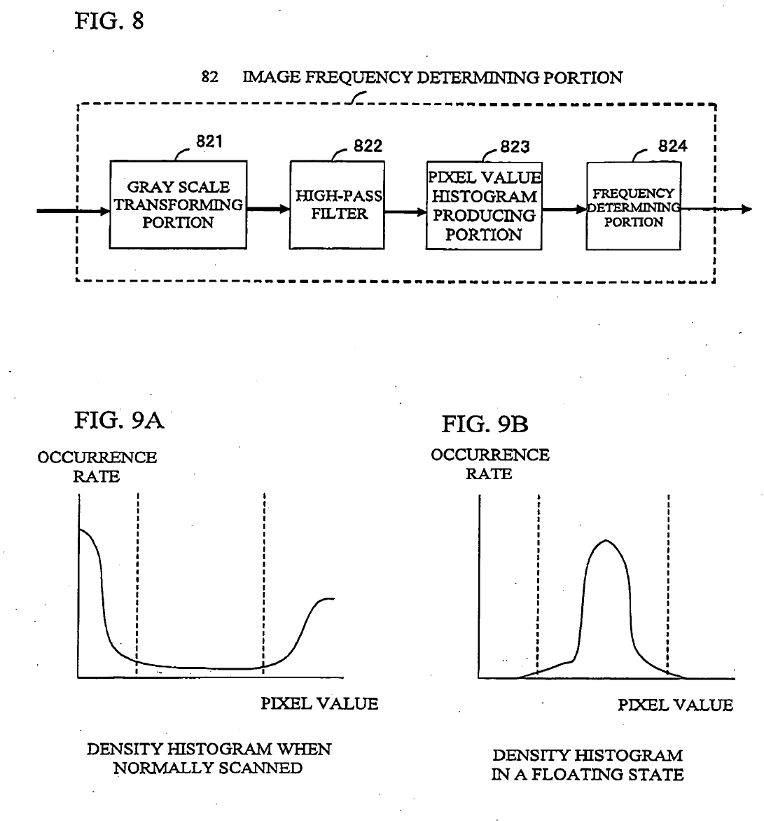

FIG. 8 is a block diagram of the image frequency determining portion 82. The image frequency determining portion 82 includes a gray scale transforming portion 821, a high-pass filter 822, a pixel value histogram producing portion 823, and a frequency determining portion 824, by reference to FIG. 8. The gray scale transforming portion 821 transforms an input image (RGB) into gray scales, at first. The high-pass filter 822 extracts high-frequency components by means of a high-pass filter. The pixel value histogram producing portion 823 plots a histogram of all the pixel values (a high-frequency component pixel value histogram).

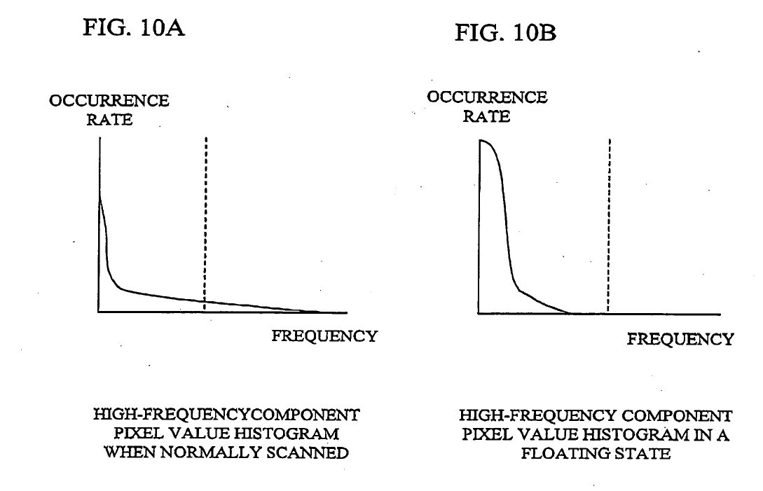

Referring to FIG. 10A and FIG. 10B, the distributions are different in the high-frequency component pixel value histogram, between a case where the image is scanned as usual (the document is placed on the platen) and a case where the document is scanned in a floating state. FIG. 10A is a high-frequency component pixel value histogram of a case where the document is scanned as usual. FIG. 10B is a high-frequency component pixel value histogram of a case where the document is scanned in a floating state. In FIG. 10A and FIG. 10, the horizontal axis denotes the pixel value, and the vertical axis denotes frequency. The frequency determining portion 824 divides the histogram into two areas, so as to determine the abnormality of the image by means of the ratio of the area having large pixel values (the area having plenty of high-frequency components). The frequency determining portion 824 determines that there is an abnormality in the image in a case where the distribution similar to FIG. 10B is obtained, because the image becomes blurred and the high-frequency components are decreased when the document is scanned in a floating state.

Referring back to FIG. 6, the determination results are respectively input into the determining portion 83. If NG is input from one of the background image density determining portion 81 and the image frequency determining portion 82, the determining portion 83 outputs a scanned image abnormality determination signal to the controller 10. The determining portion 83 determines whether or not there is an abnormality in the scanned image on the basis of the determination results thereof.

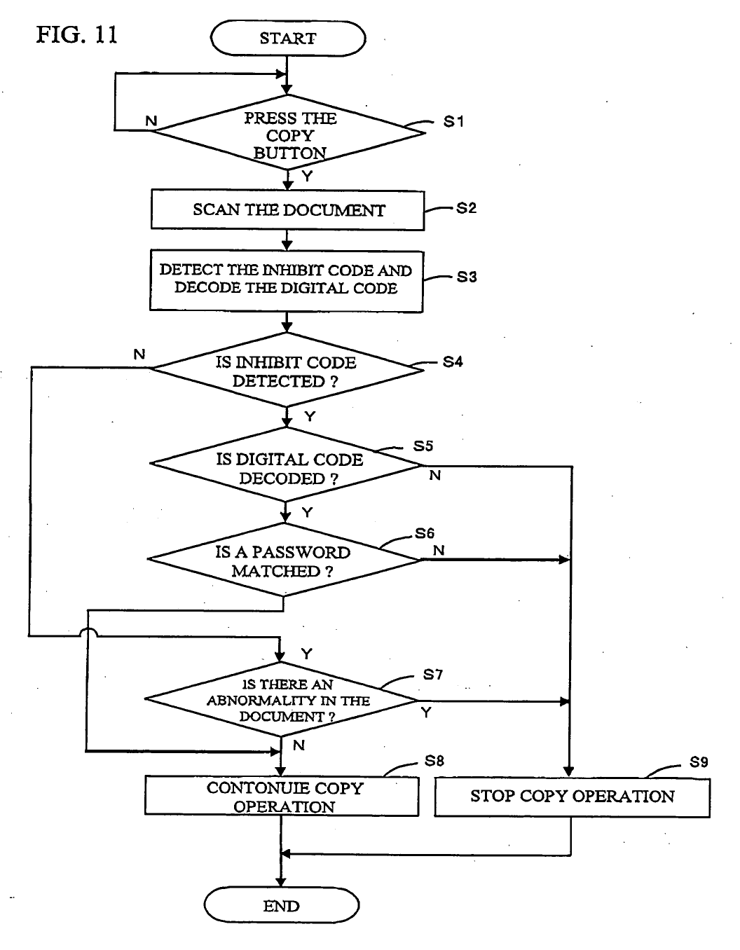

Next, a description is given to the copy operation of the multifunctional peripheral 1, according to an exemplary embodiment of the present invention. FIG. 11 is a flowchart of copy operation of the multifunctional peripheral according to an exemplary embodiment of the present invention. At step S1, the user sets the document on the platen and presses a copy button to start making a copy. If the user is a malicious one, the malicious user does not set the document on the platen and presses the copy button with the document being in a floating state several centimeters or so apart from the platen. Next, at step S2, the scanning portion 4 scans the document. The scanned image-processing portion 5 performs image processing such as image correction, color conversion, scaling up or down, and the like, and stores in the image-storing portion 3.

At step S3, such scanned image is input into the inhibit code detecting portion 6 and the digital code decoding portion 7, so as to detect the inhibit code and decode the digital code. If the inhibit code detecting portion 6 detects the inhibit code (Y at step S4), and if the digital code decoding portion 7 detects the digital code and decoding is successful (Y at step S5), the controller 10 stops the copy operation for a while so as to make the user input a password from the user interface 9. If such input password is matched with the password included in the decoded data (Y at step S6), the controller 10 continues the copy operation of the current page of the document (at step S8).

If the password is not matched (N at step S6), or if the digital code decoding portion 7 cannot detect the digital code (N at step S5), the controller 10 displays a message thereof on the user interface 9 and stops the copy operation (at step S9). At step S7, such scanned image is input into the scanned image abnormality determining portion 8 to determine whether or not there is an abnormality (whether or not the document is set in a floating state). If the scanned image abnormality determining portion 8 determines that there is an abnormality (Y at step S7), the controller 10 displays the message thereof on the user interface 9 and stops the copy operation (at step S9). Meanwhile, if the scanned image abnormality determining portion 8 determines that there is no abnormality (N at step S7), the controller 10 continues the copy operation (at step S8) and the image is copied on a paper from the printing portion 13.

As stated heretofore, the background density of the scanned whole image is detected. If the whole background has a density of equal to or greater than a given density, it is determined that the image is a tint bock background image. Consequently, copy is prohibited. In addition, the frequency components of the whole image are detected. If the image does not include the high-frequency components (the image is blurred), it is determined that the document is set in a floating state. Consequently, copy is prohibited. In this manner, even if the document is set in a floating state when it is scanned, the information can be detected from the document in which the information is embedded.

An image-processing method employed in the present invention is accomplished by the multifunctional peripheral 1. The multifunctional peripheral 1 is realized by, for example, Central Processing Unit (CPU), Read Only Memory (ROM) Random Access Memory (RAM), and the like. The image-processing method employed in the present invention can be realized as a program by controlling a computer. This program can be offered by distributing by means of a magnetic disc, an optical disc, a semiconductor memory, or another storage medium distributing through a network.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image-processing apparatus comprising:
a scanning portion that scans a document in which information is embedded;
an image-outputting portion that outputs an image of the document that has been scanned;
a detecting portion that detects information from the image of the document that has been scanned;
an abnormality determining portion that determines whether or not there is an abnormality in the image of the document that has been scanned; and
a controller that controls outputting of the image from the image-outputting portion on the basis of a detection result by the detecting portion and a determination result of the abnormality determining portion.

2. The image-processing apparatus according to claim 1, wherein the abnormality determining portion determines a case where the document is scanned in a floating state from the scanning portion, as an abnormality.

3. The image-processing apparatus according to claim 1, wherein the abnormality determining portion determines where or not there is an abnormality in the image that has been scanned, on the basis of a background density of the image that has been scanned.

4. The image-processing apparatus according to claim 1, wherein the abnormality determining portion determines where or not there is an abnormality in the image that has been scanned, on the basis of a high-frequency component in the image that has been scanned.

5. An image-processing apparatus comprising:
a detecting portion that detects information from an image of a document that has been scanned;
an abnormality determining portion that determines whether or not there is an abnormality in the image of the document that has been scanned; and
a controller that controls outputting of the image, on the basis of a detection result by the detecting portion and a determination result of the abnormality determining portion.

6. The image-processing apparatus according to claim 5, wherein the abnormality determining portion determines where or not there is an abnormality in the image that has been scanned, on the basis of a background density of the image that has been scanned.

7. The image-processing apparatus according to claim 5, wherein the abnormality determining portion determines where or not there is an abnormality in the image that has been scanned, on the basis of a high-frequency component in the image that has been scanned.

8. An image-processing method comprising:
scanning a document in which information is embedded;
outputting an image of the document that has been scanned;
detecting information from the image of the document that has been scanned;
determining whether or not there is an abnormality in the image of the document that has been scanned; and
controlling outputting of the image from the image-outputting portion, on the basis of a detection result by the detecting portion and a determination result of the abnormality determining portion.

9. The image-processing apparatus according to claim 8, wherein determining determines a case where the document is scanned in a floating state from the scanning portion, as an abnormality.

10. The image-processing apparatus according to claim 8, wherein determining determines where or not there is an abnormality in the image that has been scanned, on the basis of a background density of the image that has been scanned.

11. The image-processing apparatus according to claim 8, wherein the determining determines where or not there is an abnormality in the image that has been scanned, on the basis of a high-frequency component in the image that has been scanned.

12. A computer readable medium storing a program causing a computer to execute a process for an image processing, the process comprising:
scanning a document in which information is embedded;
outputting an image of the document that has been scanned;
detecting information from the image of the document that has been scanned;
determining whether or not there is an abnormality in the image of the document that has been scanned; and
controlling outputting of the image from the image-outputting portion, on the basis of a detection result by the detecting portion and a determination result of the abnormality determining portion.
